(19) United States
(12) Patent Application Publication
(10) Pub. No.: US 2017/0364830 A1
(43) Pub. Date: Dec. 21, 2017

(54) MACHINE LEARNING FOR AUTOMATED ORGANIZATION SYSTEM AND METHOD

(71) Applicant: Gamalon, Inc., Cambridge, MA (US)

(72) Inventors: Benjamin W. VIGODA, Winchester, MA (US); Matthew C. Barr, Malden, MA (US); Jacob E. Neely, Watertown, MA (US); Daniel F. Ring, San Francisco, CA (US)

(21) Appl. No.: 15/624,012

(22) Filed: Jun. 15, 2017

Related U.S. Application Data
(60) Provisional application No. 62/350,440, filed on Jun. 15, 2016.

(51) Int. Cl. G06N 99/00; G06F 3/0488; G06F 3/0482

(52) U.S. Cl. CPC G06N 99/005; G06F 3/0482; G06F 3/04883

(57) ABSTRACT

A method, computer program product, and computer system for identifying, by a computing device, a plurality of content from at least one source. A first portion of the plurality of content may be categorized in a first feed category based on a first probabilistic model. A second portion of the plurality of content may be categorized in a second feed category based on the first probabilistic model. User feedback may be received to change the categorization of a first content of the first portion of the plurality of content in the first feed category to the second feed category. A second probabilistic model may be generated based upon, at least in part, the user feedback. The categorization of a second content of the first portion of the plurality of content in the first feed category may be reorganized to the second feed category based upon, at least in part, the second probabilistic model.

### RELATED CASES

This application claims the benefit of U.S. Provisional Application No. 62/350,440, filed on 15 Jun. 2016, the contents of which are all incorporated by reference.

### BACKGROUND

People, especially busy professionals, may contend with a deluge of information and it may be overwhelming. The information may come in one or more forms, from one or more sources, and may include such things as, e.g., SMS messages, documents, webpages, email alerts, email, blogs, news feeds, social media messages/feeds, and many others.

### BRIEF SUMMARY OF DISCLOSURE

In one example implementation, a method, performed by one or more computing devices, may include but is not limited to identifying, by a computing device, a plurality of content from at least one source. A first portion of the plurality of content may be categorized in a first feed category based on a first probabilistic model. A second portion of the plurality of content may be categorized in a second feed category based on the first probabilistic model. User feedback may be received to change the categorization of a first content of the first portion of the plurality of content in the first feed category to the second feed category. A second probabilistic model may be generated based upon, at least in part, the user feedback. The categorization of a second content of the first portion of the plurality of content in the first feed category may be reorganized based upon, at least in part, the second probabilistic model.

One or more of the following example features may be included. The second feed category may be a sub-feed of the first feed category. Reorganizing the categorization of the second content of the first portion of the plurality of content in the first feed category may include removing the second content from the first feed category. The user feedback may be received via a user interface of a second computing device. The user feedback received via the user interface may include a gesture. Receiving the user feedback may include receiving user feedback from a plurality of users. At least one of the first probabilistic model and the second probabilistic model may be generated via machine learning.

In another example implementation, a computing system may include one or more processors and one or more memories configured to perform operations that may include but are not limited to identifying a plurality of content from at least one source. A first portion of the plurality of content may be categorized in a first feed category based on a first probabilistic model. A second portion of the plurality of content may be categorized in a second feed category based on the first probabilistic model. User feedback may be received to change the categorization of a first content of the first portion of the plurality of content in the first feed category to the second feed category. A second probabilistic model may be generated based upon, at least in part, the user feedback. The categorization of a second content of the first portion of the plurality of content in the first feed category may be reorganized based upon, at least in part, the second probabilistic model.

One or more of the following example features may be included. The second feed category may be a sub-feed of the first feed category. Reorganizing the categorization of the second content of the first portion of the plurality of content in the first feed category may include removing the second content from the first feed category. The user feedback may be received via a user interface of a computing device. The user feedback received via the user interface may include a gesture. Receiving the user feedback may include receiving user feedback from a plurality of users. At least one of the first probabilistic model and the second probabilistic model may be generated via machine learning.

In another example implementation, a computer program product may reside on a computer readable storage medium having a plurality of instructions stored thereon which, when executed across one or more processors, may cause at least a portion of the one or more processors to perform operations that may include but are not limited to identifying a plurality of content from at least one source. A first portion of the plurality of content may be categorized in a first feed category based on a first probabilistic model. A second portion of the plurality of content may be categorized in a second feed category based on the first probabilistic model. User feedback may be received to change the categorization of a first content of the first portion of the plurality of content in the first feed category to the second feed category. A second probabilistic model may be generated based upon, at least in part, the user feedback. The categorization of a second content of the first portion of the plurality of content in the first feed category may be reorganized based upon, at least in part, the second probabilistic model.

One or more of the following example features may be included. The second feed category may be a sub-feed of the first feed category. Reorganizing the categorization of the second content of the first portion of the plurality of content in the first feed category may include removing the second content from the first feed category. The user feedback may be received via a user interface of a computing device. The user feedback received via the user interface may include a gesture. Receiving the user feedback may include receiving user feedback from a plurality of users. At least one of the first probabilistic model and the second probabilistic model may be generated via machine learning.

The details of one or more example implementations are set forth in the accompanying drawings and the description below. Other possible example features and/or possible example advantages will become apparent from the description, the drawings, and the claims. Some implementations may not have those possible example features and/or possible example advantages, and such possible example features and/or possible example advantages may not necessarily be required of some implementations.

### BRIEF DESCRIPTION OF THE DRAWINGS

FIG. 1 is an example diagrammatic view of an organization process coupled to an example distributed computing network according to one or more example implementations of the disclosure;

FIG. 2 is an example diagrammatic view of a client electronic device of FIG. 1 according to one or more example implementations of the disclosure;

FIG. 3 is an example flowchart of an organization process according to one or more example implementations of the disclosure; and

FIGS. 4-15 are example diagrammatic views of a screen image displayed by an organization process according to one or more example implementations of the disclosure.

Like reference symbols in the various drawings indicate like elements.

### DETAILED DESCRIPTION

### System Overview:

People, especially busy professionals, may contend with a deluge of information and it may be overwhelming. The information may come in one or more forms, from one or more sources, and may include such things as, e.g., SMS messages, documents, webpages, email alerts, email, blogs, news feeds, social media messages/feeds, and many others.

For instance, using email as an example, one's email may come from many different sources. One person may be sent an email to do something for a project being worked on with another. Later, one may be sent an unrelated email asking if the group should buy a new printer. Generally, one's email browser may show these emails in chronological order, one right after the other, regardless of the fact that moving from one to the next may require an entire context switch for your brain. Documents from multiple unrelated sources and multiple unrelated topics may be interleaved and shuffled together with no rhyme or reason.

Another example of this lack of organization when viewing “documents” is tabs in a web browser. For example, if someone sends one an email containing a link to a webpage that they think one would find interesting or useful, when one clicks on it, it may open in one of the browser tabs next to other unrelated webpages. Soon, one may have many webpages open in many browser tabs, and they may not be well organized.

Another example, one may have documents in one's file system on the computer, on a file share, or on the cloud. One may organize files into folders. Ideally, other people who share access to the file system are careful about filing documents into the same folder ontology. But even if they do, the file share itself may be separate from one's email, one's web browser, one's social media feed, and all of one's other information inflows. For instance, if one's social media messages, two webpages, an email thread, and three Word documents are all useful and relevant to one at the same time for the project one may happen to be working on, they may all be in separate browsers in different places, and one might spend time just getting them all open in one place on one's computer to start work on the project with each of these resources handy.

The situation may be exacerbated on one's phone or tablet or other smaller screen mobile computing device. For those devices, to get something done that requires multiple documents, one may have to constantly switch between different apps, and then scroll or move to the relevant document within each app.

One reason for this limitation of the state of the art may be that each company may be focused on curating their single kind of feed. For example, social media sites may focus on getting one relevant social media feeds via their social media app. Search engines may focus on providing one with a list of relevant webpages to view in their search results page. Webpage alerts may focus on providing links to webpages in received emails. People or feeds that send one email or other kinds of messages may be focused on telling one something, and they may have no idea what other messages or documents someone else might be sending one around the same time. The result may be that all of one's information may be disorganized and in different places and one may feel overwhelmed. Especially on mobile devices, it may become difficult to get work done, aside from reading email and possibly responding to a emails.

As such, the present disclosure may deal with these example issues that each source of documents that one may consume has no way of knowing about the documents coming from other sources, and therefore all of one's sources may be merged together in a disorganized way or not merged together at all. As will be discussed in greater detail below, the present disclosure may take all of these information feeds, and automatically re-collate and organize them into an ontology that may be beneficial for how and/or when one plans to use or consume the information.

In some implementations, the present disclosure may be embodied as a method, system, or computer program product. Accordingly, in some implementations, the present disclosure may take the form of an entirely hardware implementation, an entirely software implementation (including firmware, resident software, micro-code, etc.) or an implementation combining software and hardware aspects that may all generally be referred to herein as a “circuit,” “module” or “system.” Furthermore, in some implementations, the present disclosure may take the form of a computer program product on a computer-usable storage medium having computer-usable program code embodied in the medium.

In some implementations, any suitable computer usable or computer readable medium (or media) may be utilized. The computer readable medium may be a computer readable signal medium or a computer readable storage medium. The computer-usable, or computer-readable, storage medium (including a storage device associated with a computing device or client electronic device) may be, for example, but is not limited to, an electronic, magnetic, optical, electromagnetic, infrared, or semiconductor system, apparatus, device, or any suitable combination of the foregoing. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a digital versatile disk (DVD), a static random access memory (SRAM), a memory stick, a floppy disk, a mechanically encoded device such as punch-cards or raised structures in a groove having instructions recorded thereon, a media such as those supporting the internet or an intranet, or a magnetic storage device. Note that the computer-usable or computer-readable medium could even be a suitable medium upon which the program is stored, scanned, compiled, interpreted, or otherwise processed in a suitable manner, if necessary, and then stored in a computer memory. In the context of the present disclosure, a computer-usable or computer-readable, storage medium may be any tangible medium that can contain or store a program for use by or in connection with the instruction execution system, apparatus, or device.

In some implementations, a computer readable signal medium may include a propagated data signal with computer readable program code embodied therein, for example, in baseband or as part of a carrier wave. In some implementations, such a propagated signal may take any of a variety of forms, including, but not limited to, electro-magnetic, optical, or any suitable combination thereof. In some implementations, the computer readable program code may be transmitted using any appropriate medium, including but not limited to the internet, wireline, optical fiber cable, RF, etc. In some implementations, a computer readable signal medium may be any computer readable medium that is not a computer readable storage medium and that can communicate, propagate, or transport a program for use by or in connection with an instruction execution system, apparatus, or device.

In some implementations, computer program code for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java®, Smalltalk, C++ or the like. Java® and all Java-based trademarks and logos are trademarks or registered trademarks of Oracle and/or its affiliates. However, the computer program code for carrying out operations of the present disclosure may also be written in conventional procedural programming languages, such as the “C” programming language, PASCAL, or similar programming languages, as well as in scripting languages such as Javascript, PERL, or Python. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the internet using an Internet Service Provider). In some implementations, electronic circuitry including, for example, programmable logic circuitry, field-programmable gate arrays (FPGAs) or other hardware accelerators, micro-controller units (MCUs), or programmable logic arrays (PLAs) may execute the computer readable program instructions/code by utilizing state information of the computer readable program instructions to personalize the electronic circuitry, in order to perform aspects of the present disclosure.

In some implementations, the flowchart and block diagrams in the figures illustrate the architecture, functionality, and operation of possible implementations of apparatus (systems), methods and computer program products according to various implementations of the present disclosure. Each block in the flowchart and/or block diagrams, and combinations of blocks in the flowchart and/or block diagrams, may represent a module, segment, or portion of code, which comprises one or more executable computer program instructions for implementing the specified logical function(s)/act(s). These computer program instructions may be provided to a processor of a general purpose computer, special purpose computer, or other programmable data processing apparatus to produce a machine, such that the computer program instructions, which may execute via the processor of the computer or other programmable data processing apparatus, create the ability to implement one or more of the functions/acts specified in the flowchart and/or block diagram block or blocks or combinations thereof. It should be noted that, in some implementations, the functions noted in the block(s) may occur out of the order noted in the figures. For example, two blocks shown in succession may, in fact, be executed substantially concurrently, or the blocks may sometimes be executed in the reverse order, depending upon the functionality involved.

In some implementations, these computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks or combinations thereof.

In some implementations, the computer program instructions may also be loaded onto a computer or other programmable data processing apparatus to cause a series of operational steps to be performed (not necessarily in a particular order) on the computer or other programmable apparatus to produce a computer implemented process such that the instructions which execute on the computer or other programmable apparatus provide steps for implementing the functions/acts (not necessarily in a particular order) specified in the flowchart and/or block diagram block or blocks or combinations thereof.

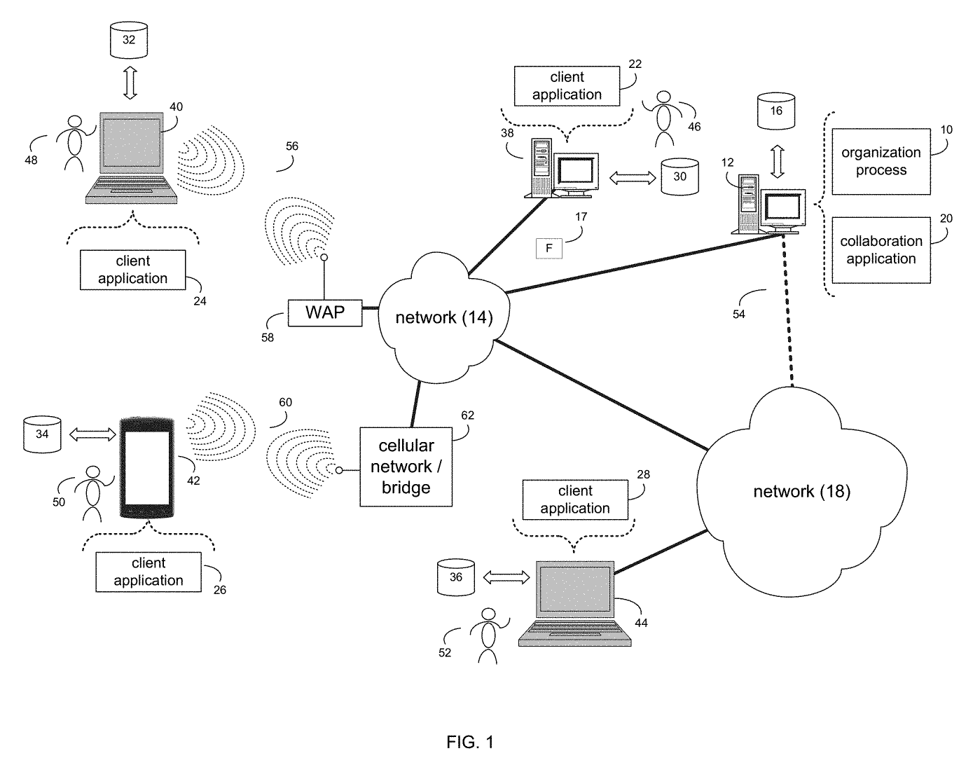

Referring now to the example implementation of FIG. 1, there is shown organization process (OP) 10 that may reside on and may be executed by a computer (e.g., computer 12), which may be connected to a network (e.g., network 14) (e.g., the internet or a local area network). Examples of computer 12 (and/or one or more of the client electronic devices noted below) may include, but are not limited to, a personal computer(s), a laptop computer(s), mobile computing device(s), a server computer, a series of server computers, a mainframe computer(s), or a computing cloud(s). In some implementations, each of the aforementioned may be generally described as a computing device. In certain implementations, a computing device may be a physical or virtual device. In many implementations, a computing device may be any device capable of performing operations, such as a dedicated processor, a portion of a processor, a virtual processor, a portion of a virtual processor, portion of a virtual device, or a virtual device. In some implementations, a processor may be a physical processor or a virtual processor. In some implementations, a virtual processor may correspond to one or more parts of one or more physical processors. In some implementations, the instructions/logic may be distributed and executed across one or more processors, virtual or physical, to execute the instructions/logic. Computer 12 may execute an operating system, for example, but not limited to, Microsoft® Windows®; Mac® OS X®; Red Hat® Linux®, Windows® Mobile, Chrome OS, Blackberry OS, Fire OS, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

In some implementations, as will be discussed below in greater detail, an OP, such as OP 10 of FIG. 1, may identify, by a computing device, a plurality of content from at least one source. A first portion of the plurality of content may be categorized in a first feed category based on a first probabilistic model. A second portion of the plurality of content may be categorized in a second feed category based on the first probabilistic model. User feedback (e.g., feedback 17) may be received to change the categorization of a first content of the first portion of the plurality of content in the first feed category to the second feed category. A second probabilistic model may be generated based upon, at least in part, the user feedback. The categorization of a second content of the first portion of the plurality of content in the first feed category may be reorganized based upon, at least in part, the second probabilistic model.

In some implementations, the instruction sets and subroutines of OP 10, which may be stored on storage device, such as storage device 16, coupled to computer 12, may be executed by one or more processors and one or more memory architectures included within computer 12. In some implementations, storage device 16 may include but is not limited to: a hard disk drive; a flash drive, a tape drive; an optical drive; a RAID array (or other array); a random access memory (RAM); and a read-only memory (ROM).

In some implementations, network 14 may be connected to one or more secondary networks (e.g., network 18), examples of which may include but are not limited to: a local area network; a wide area network; or an intranet, for example.

In some implementations, computer 12 may include a data store, such as a database (e.g., relational database, object-oriented database, triplestore database, etc.) and may be located within any suitable memory location, such as storage device 16 coupled to computer 12. In some implementations, data, metadata, information, etc. described throughout the present disclosure may be stored in the data store. In some implementations, computer 12 may utilize any known database management system such as, but not limited to, DB2, in order to provide multi-user access to one or more databases, such as the above noted relational database. In some implementations, the data store may also be a custom database, such as, for example, a flat file database or an XML database. In some implementations, any other form(s) of a data storage structure and/or organization may also be used. In some implementations, OP 10 may be a component of the data store, a standalone application that interfaces with the above noted data store and/or an applet/application that is accessed via client applications 22, 24, 26, 28. In some implementations, the above noted data store may be, in whole or in part, distributed in a cloud computing topology. In this way, computer 12 and storage device 16 may refer to multiple devices, which may also be distributed throughout the network.

In some implementations, computer 12 may execute a collaboration application (e.g., collaboration application 20), examples of which may include, but are not limited to, e.g., a web conferencing application, a video conferencing application, a voice-over-IP application, a video-over-IP application, an Instant Messaging (IM)/“chat” application, a short messaging service (SMS)/multimedia messaging service (MMS) application, an email application, a social media application, a website application, or other application that allows for virtual meeting and/or remote collaboration. In some implementations, OP 10 and/or collaboration application 20 may be accessed via one or more of client applications 22, 24, 26, 28. In some implementations, OP 10 may be a standalone application, or may be an applet/application/script/extension that may interact with and/or be executed within collaboration application 20, a component of collaboration application 20, and/or one or more of client applications 22, 24, 26, 28. In some implementations, collaboration application 20 may be a standalone application, or may be an applet/application/script/extension that may interact with and/or be executed within OP 10, a component of OP 10, and/or one or more of client applications 22, 24, 26, 28. In some implementations, one or more of client applications 22, 24, 26, 28 may be a standalone application, or may be an applet/application/script/extension that may interact with and/or be executed within and/or be a component of OP 10 and/or collaboration application 20. Examples of client applications 22, 24, 26, 28 may include, but are not limited to, e.g., a web conferencing application, a video conferencing application, a voice-over-IP application, a video-over-IP application, an Instant Messaging (IM)/“chat” application, a short messaging service (SMS)/multimedia messaging service (MMS) application, an email application, a social media application, a website application, or other application that allows for virtual meeting and/or remote collaboration, a standard and/or mobile web browser, an email application (e.g., an email client application), a textual and/or a graphical user interface, a customized web browser, a plugin, an Application Programming Interface (API), or a custom application. The instruction sets and subroutines of client applications 22, 24, 26, 28, which may be stored on storage devices 30, 32, 34, 36, coupled to client electronic devices 38, 40, 42, 44, may be executed by one or more processors and one or more memory architectures incorporated into client electronic devices 38, 40, 42, 44.

In some implementations, one or more of storage devices 30, 32, 34, 36, may include but are not limited to: hard disk drives; flash drives, tape drives; optical drives; RAID arrays; random access memories (RAM); and read-only memories (ROM). Examples of client electronic devices 38, 40, 42, 44 (and/or computer 12) may include, but are not limited to, a personal computer (e.g., client electronic device 38), a laptop computer (e.g., client electronic device 40), a smart/data-enabled, cellular phone (e.g., client electronic device 42), a notebook computer (e.g., client electronic device 44), a tablet, a server, a television, a smart television, a media (e.g., video, photo, etc.) capturing device, and a dedicated network device. Client electronic devices 38, 40, 42, 44 may each execute an operating system, examples of which may include but are not limited to, Android™, Apple® iOS®, Mac® OS X®; Red Hat® Linux®, Windows® Mobile, Chrome OS, Blackberry OS, Fire OS, or a custom operating system.

In some implementations, one or more of client applications 22, 24, 26, 28 may be configured to effectuate some or all of the functionality of OP 10 (and vice versa). Accordingly, in some implementations, OP 10 may be a purely server-side application, a purely client-side application, or a hybrid server-side/client-side application that is cooperatively executed by one or more of client applications 22, 24, 26, 28 and/or OP 10.

In some implementations, one or more of client applications 22, 24, 26, 28 may be configured to effectuate some or all of the functionality of collaboration application 20 (and vice versa). Accordingly, in some implementations, collaboration application 20 may be a purely server-side application, a purely client-side application, or a hybrid server-side/client-side application that is cooperatively executed by one or more of client applications 22, 24, 26, 28 and/or collaboration application 20. As one or more of client applications 22, 24, 26, 28, OP 10, and collaboration application 20, taken singly or in any combination, may effectuate some or all of the same functionality, any description of effectuating such functionality via one or more of client applications 22, 24, 26, 28, OP 10, collaboration application 20, or combination thereof, and any described interaction(s) between one or more of client applications 22, 24, 26, 28, OP 10, collaboration application 20, or combination thereof to effectuate such functionality, should be taken as an example only and not to limit the scope of the disclosure.

In some implementations, one or more of users 46, 48, 50, 52 may access computer 12 and OP 10 (e.g., using one or more of client electronic devices 38, 40, 42, 44) directly through network 14 or through secondary network 18. Further, computer 12 may be connected to network 14 through secondary network 18, as illustrated with phantom link line 54. OP 10 may include one or more user interfaces, such as browsers and textual or graphical user interfaces, through which users 46, 48, 50, 52 may access OP 10.

In some implementations, the various client electronic devices may be directly or indirectly coupled to network 14 (or network 18). For example, client electronic device 38 is shown directly coupled to network 14 via a hardwired network connection. Further, client electronic device 44 is shown directly coupled to network 18 via a hardwired network connection. Client electronic device 40 is shown wirelessly coupled to network 14 via wireless communication channel 56 established between client electronic device 40 and wireless access point (i.e., WAP) 58, which is shown directly coupled to network 14. WAP 58 may be, for example, an IEEE 802.11a, 802.11b, 802.11g, 802.11n, 802.11ac, Wi-Fi®, RFID, and/or Bluetooth™ (including Bluetooth™ Low Energy) device that is capable of establishing wireless communication channel 56 between client electronic device 40 and WAP 58. Client electronic device 42 is shown wirelessly coupled to network 14 via wireless communication channel 60 established between client electronic device 42 and cellular network/bridge 62, which is shown by example directly coupled to network 14.

In some implementations, some or all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. Bluetooth™ (including Bluetooth™ Low Energy) is a telecommunications industry specification that allows, e.g., mobile phones, computers, smart phones, and other electronic devices to be interconnected using a short-range wireless connection. Other forms of interconnection (e.g., Near Field Communication (NFC)) may also be used.

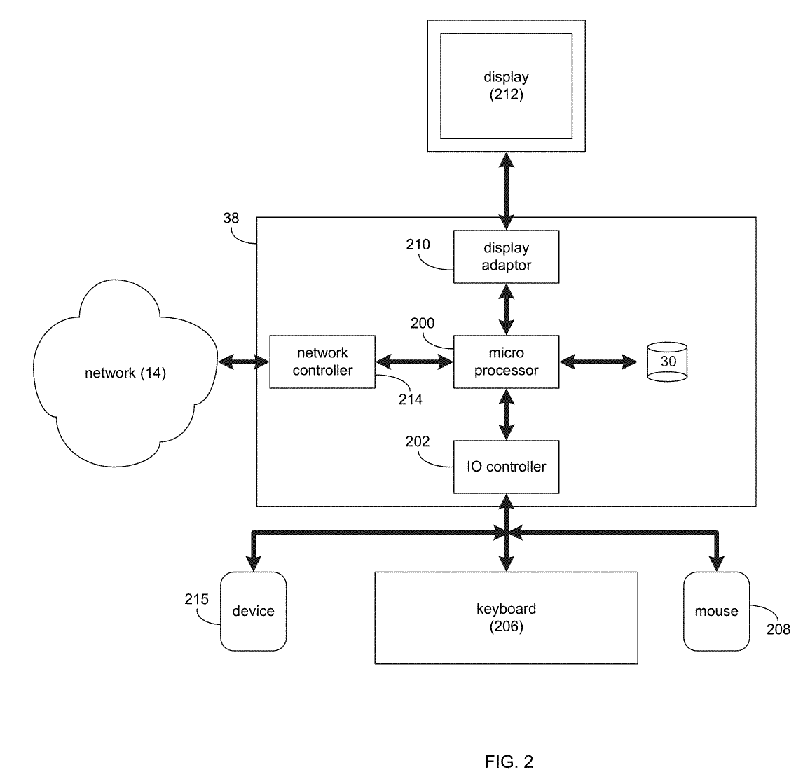

Referring also to the example implementation of FIG. 2, there is shown a diagrammatic view of client electronic device 38. While client electronic device 38 is shown in this figure, this is for example purposes only and is not intended to be a limitation of this disclosure, as other configurations are possible. Additionally, any computing device capable of executing, in whole or in part, OP 10 may be substituted for client electronic device 38 (in whole or in part) within FIG. 2, examples of which may include but are not limited to computer 12 and/or one or more of client electronic devices 38, 40, 42, 44.

In some implementations, client electronic device 38 may include a processor (e.g., microprocessor 200) configured to, e.g., process data and execute the above-noted code/instruction sets and subroutines. Microprocessor 200 may be coupled via a storage adaptor to the above-noted storage device(s) (e.g., storage device 30). An I/O controller (e.g., I/O controller 202) may be configured to couple microprocessor 200 with various devices (e.g., via wired or wireless connection), such as keyboard 206, pointing/selecting device (e.g., touchpad, touchscreen, mouse 208, etc.), custom device (e.g., device 215), USB ports, and printer ports. A display adaptor (e.g., display adaptor 210) may be configured to couple display 212 (e.g., touchscreen monitor(s), plasma, CRT, or LCD monitor(s), etc.) with microprocessor 200, while network controller/adaptor 214 (e.g., an Ethernet adaptor) may be configured to couple microprocessor 200 to the above-noted network 14 (e.g., the Internet or a local area network).

As will be discussed below, OP 10 may at least help, e.g., improve existing feed organizational technologies necessarily rooted in machine learning computer technology, in order to overcome an example and non-limiting problem specifically arising in the realm of computer networks, and improve existing technological processes associated with, e.g., culminating, organizing, and/or providing multiple content from feeds using machine learning technology.

The Organization Process:

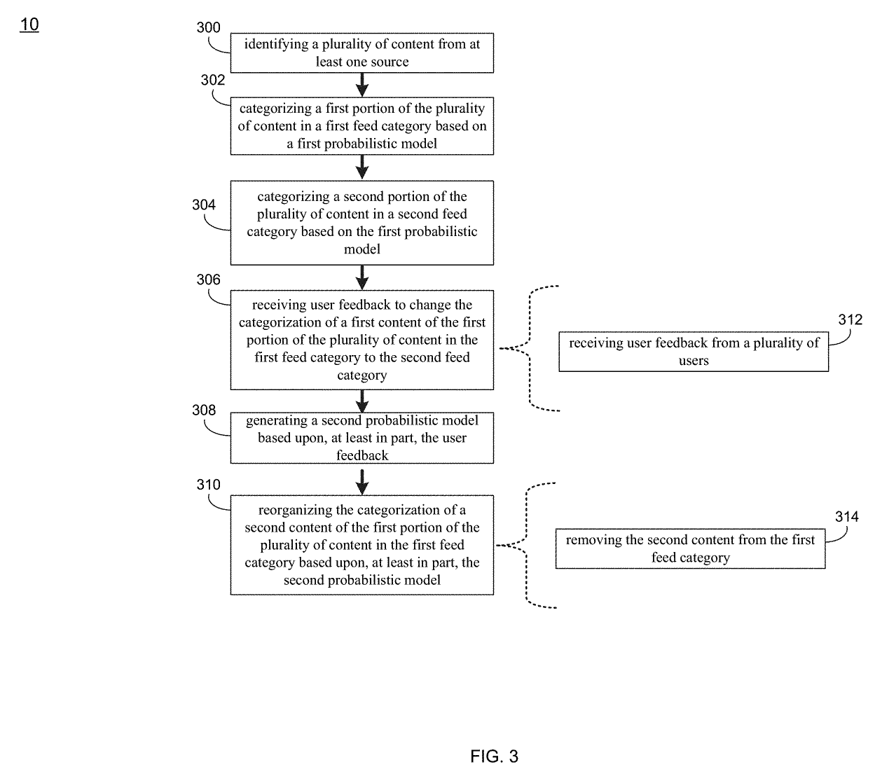

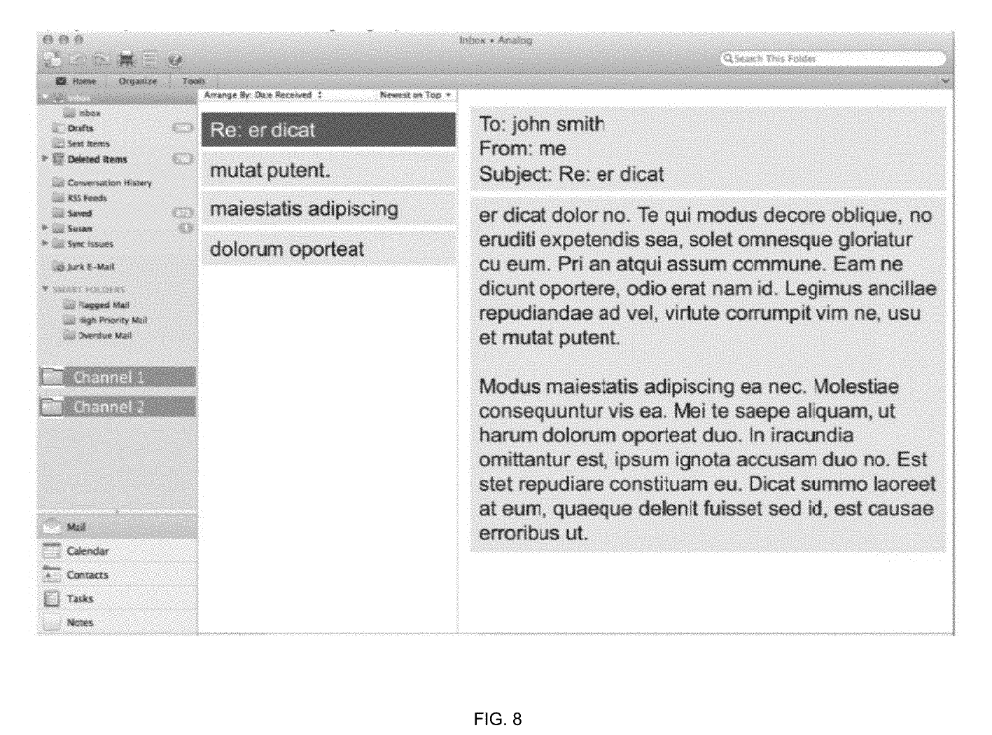

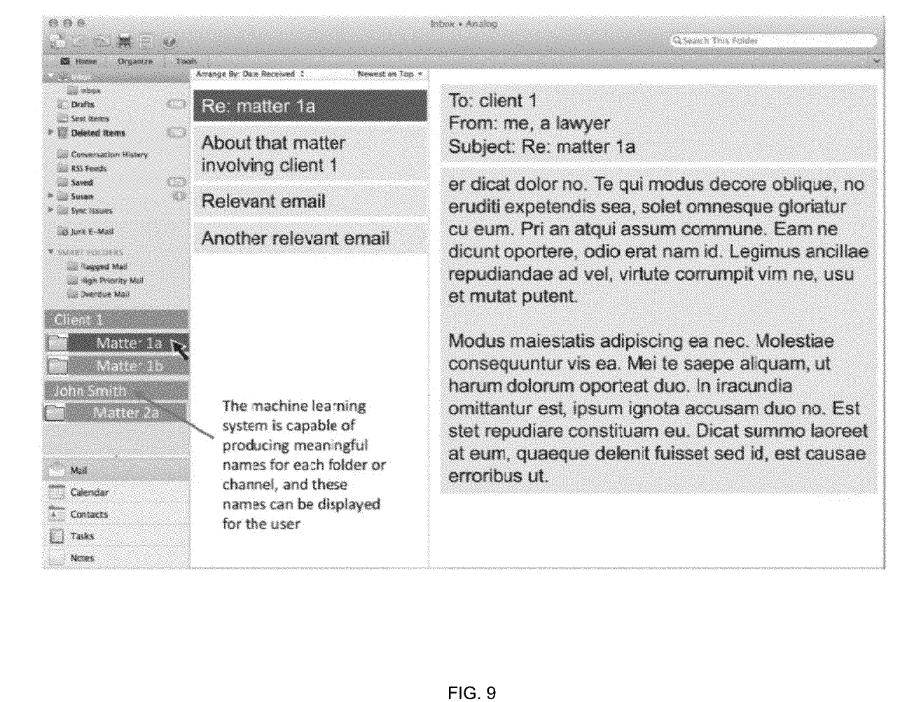

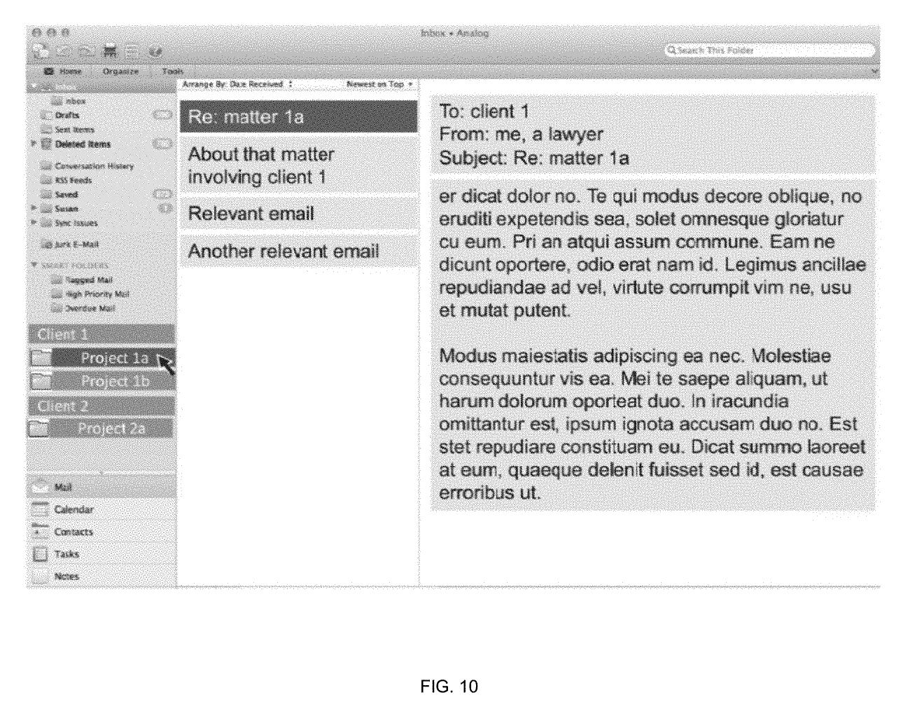

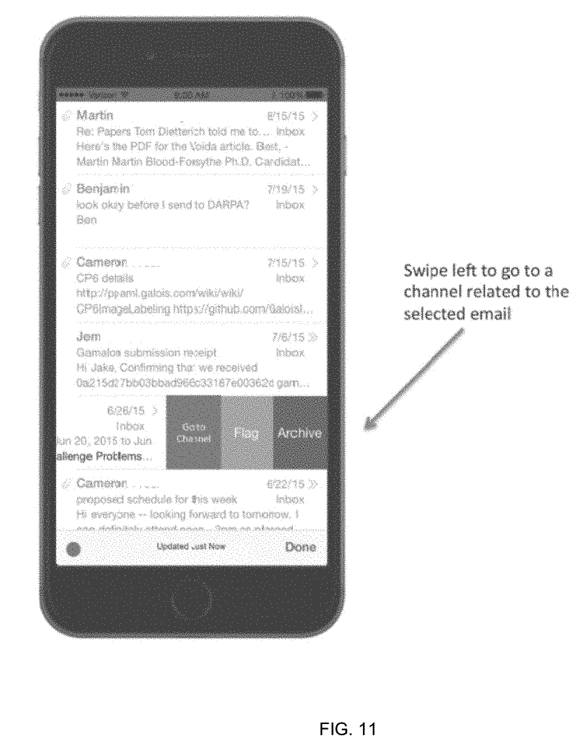

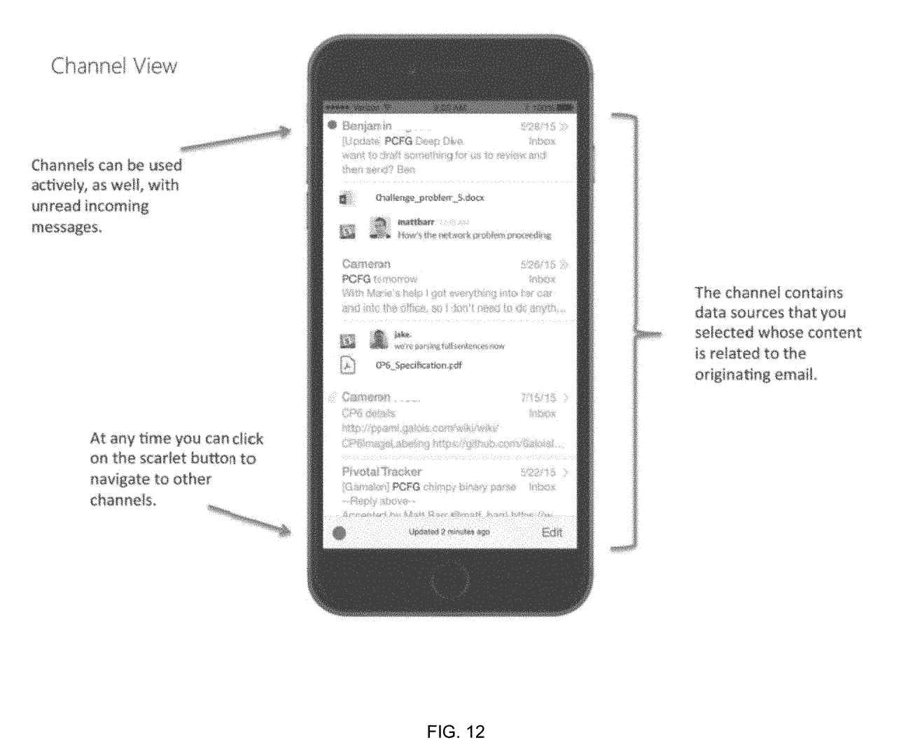

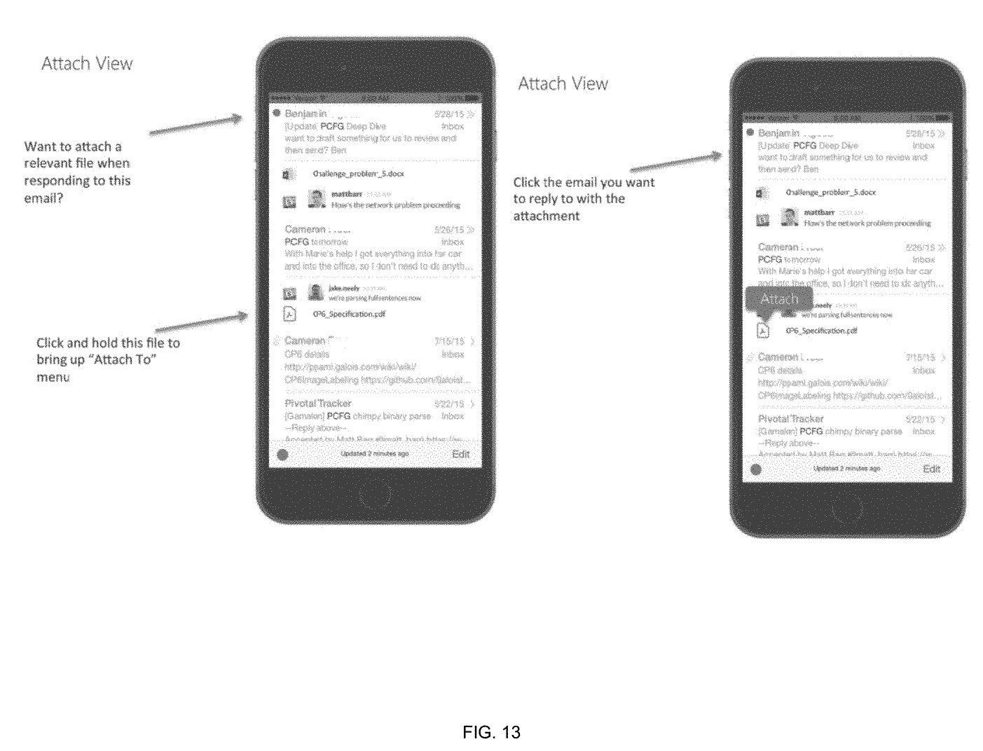

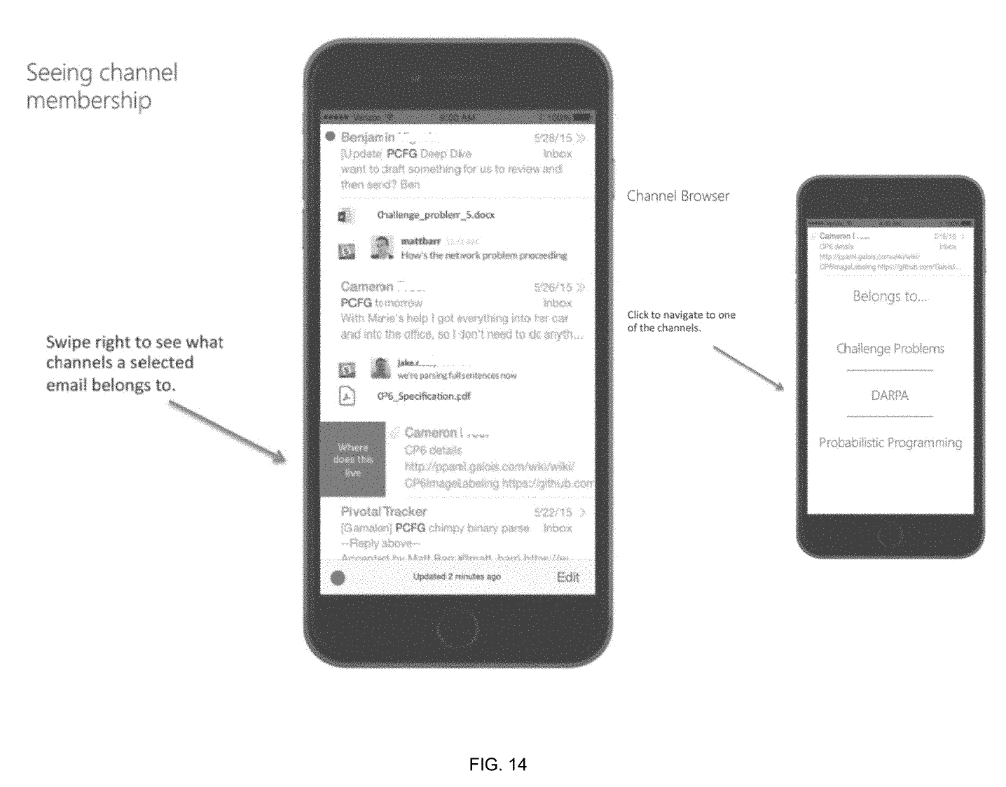

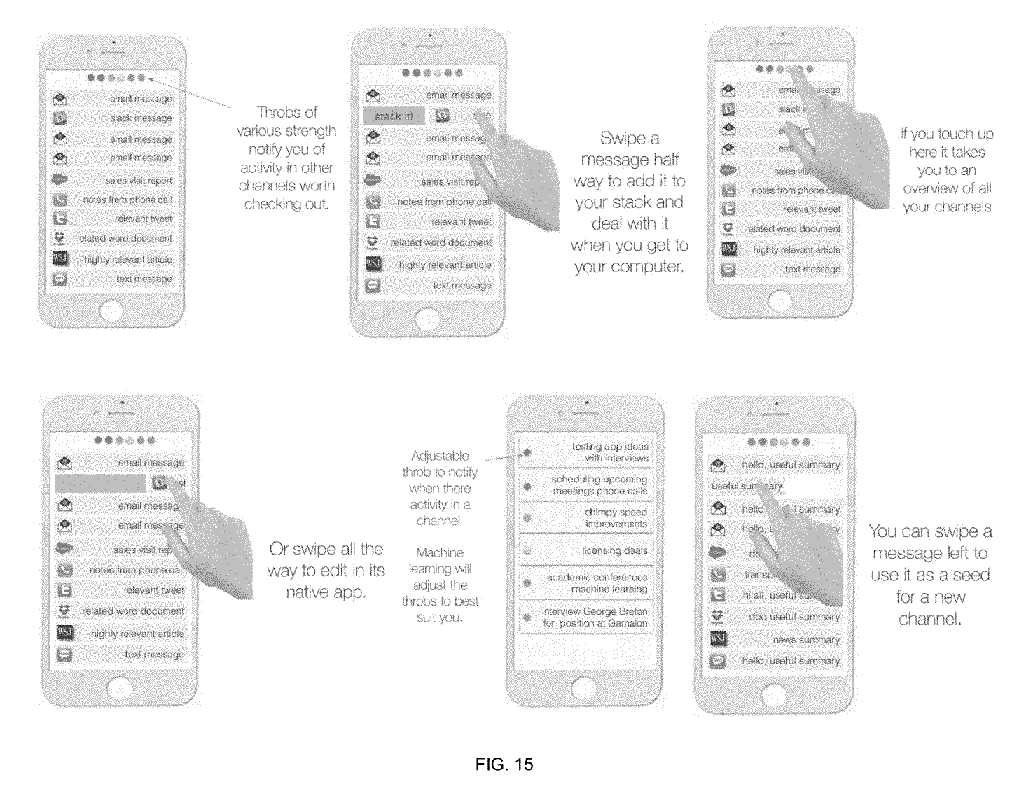

As discussed above and referring also at least to the example implementations of FIGS. 3-15, organization process (OP) 10 may identify 300, by a computing device, a plurality of content from at least one source. OP 10 may categorize 302 a first portion of the plurality of content in a first feed category based on a first probabilistic model. OP 10 may categorize 304 a second portion of the plurality of content in a second feed category based on the first probabilistic model. OP 10 may receive 306 user feedback to change the categorization of a first content of the first portion of the plurality of content in the first feed category to the second feed category. OP 10 may generate 308 a second probabilistic model based upon, at least in part, the user feedback. OP 10 may reorganize 310 the categorization of a second content of the first portion of the plurality of content in the first feed category based upon, at least in part, the second probabilistic model.

In some implementations, organization process (OP) 10 may identify 300, by a computing device (e.g., computer 12), a plurality of content from at least one source. For instance, assume for example purposes only that that an email server is the source. In the example, one or more emails received by a user (e.g., user 50) may be the content identified 300 by OP 10. It will be appreciated that the source may include other sources. For example, user 50 may receive content/communication in the form of, e.g., tweets, instant messages, text messages, or any other form of digital communication including those noted above. As such, the use of emails as “content” should be taken as example only and not to otherwise limit the scope of the disclosure.

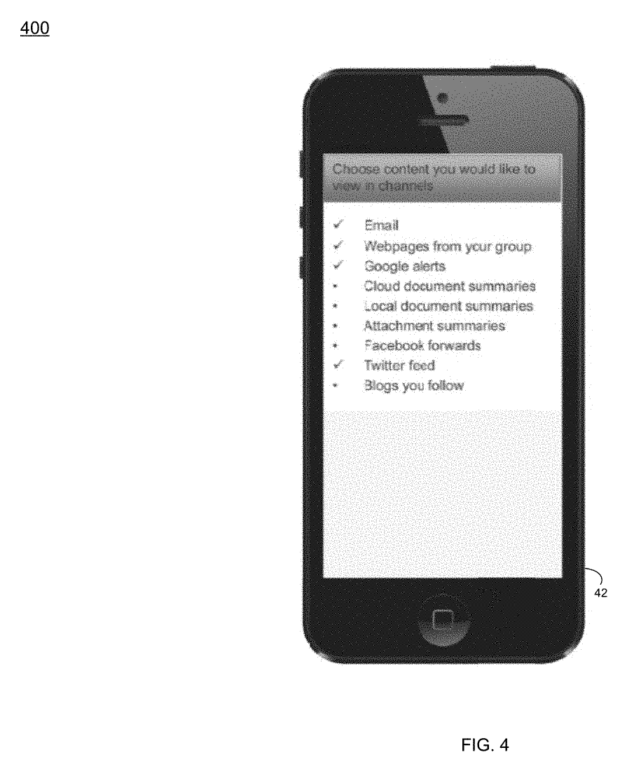

In some implementations, and referring at least to the example implementation of FIG. 4, an example user interface 400 associated with OP 10 is shown. In the example, user interface 400 (via OP 10) may enable a user (e.g., user 50) to select (or deselect) multiple sources for content that may be identified 300 by OP 10. For example, content may be identified 300 from multiple sources selected by user 50, such as, e.g., the local file system, a document file share, a cloud based file share, emails, SMS messages, documents, webpages, email alerts, blogs, news feeds, social media messages/feeds, voicemails, meeting minutes, etc., or combinations thereof. As such, the use of a single source of content should be taken as example only and not to otherwise limit the scope of the disclosure.

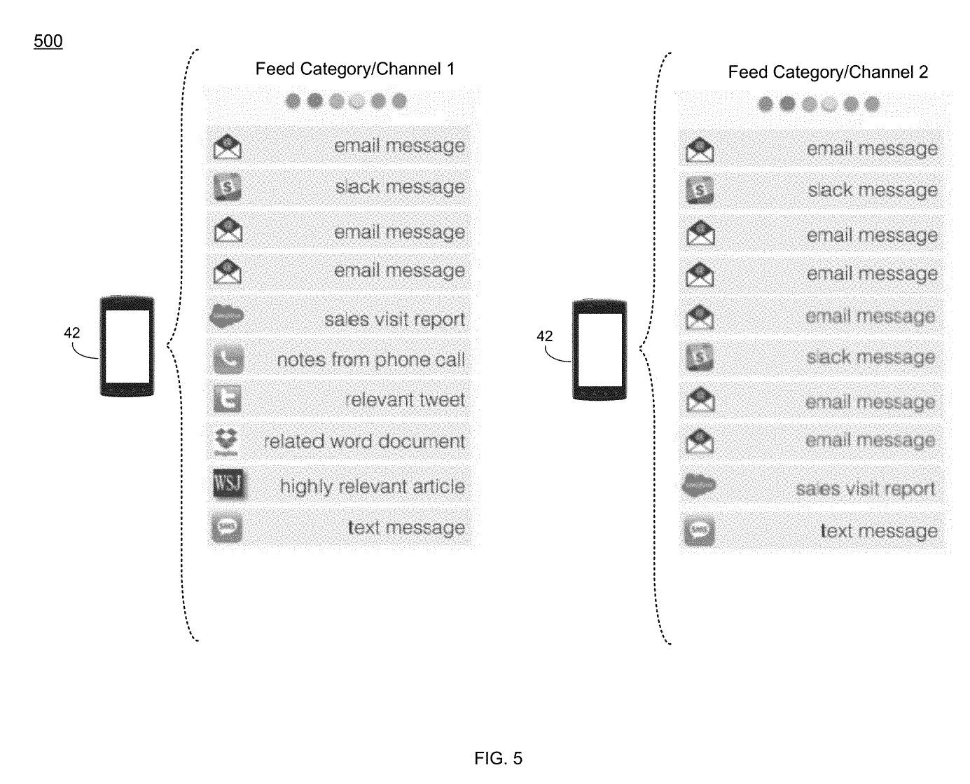

In some implementations, OP 10 may categorize 302 a first portion of the plurality of content in a first feed category based on a first probabilistic model and OP 10 may categorize 304 a second portion of the plurality of content in a second feed category based on the first probabilistic model. For instance, and referring at least to the example implementation of FIG. 5, an example user interface 500 associated with OP 10 is shown. In the example, user interface 500 (via OP 10) may be used to display portions of the content categorized 302 into a first feed category (e.g., “channel 1”) based upon a first probabilistic model, and portions of the content categorized 304 into a second feed category (e.g., “channel 2”) based upon the first probabilistic model. In the example, OP 10 may use machine learning for the example purpose of, e.g., supporting group collaboration via any messaging capable software application (server or client) and any messaging modality (email, text, voice, etc.). In some implementations, the probabilistic model may include a discriminative model (e.g., a probabilistic model for only the variables of interest), a generative model (e.g., a full probabilistic model of all variables), or a combination thereof.

In some implementations, OP 10 may use machine learning system to categorize 302/304 the content by, e.g., inferring latent variables from structured and unstructured communication arising in a collaboration, such as: which projects are active, which members are working on which projects and how much, predicted project timelines and progress, which emails are related to which project, keywords or semantic groups of words that are related to particular projects, and the temporal state of a project or relationship. In some implementations, OP 10 may use machine learning to generate titles automatically for the channels by, e.g., looking for statistically salient N grams in the content within that channel, and/or user 50 may generate his/her own titles. For instance, an example title may be “Patents.” In the example, statistically, “Patents” may be a word or words that is used frequently in a particular feed category, or a word or words that is used frequently and early on to “kick off” a conversation, or a word or words that is used by a person who is a hub in the conversation (e.g., a person who statistically people tend to email and the person tends to respond to everyone), frequently and early on in the conversation.

In some implementations, the probabilistic model used to categorize 302/304 the content into its appropriate channel may include “feeding” the content into an unsupervised topic model. In other examples, the topic model may be supervised or semi-supervised. An example of a topic model may be Latent Dirichlet Allocation (LDA). Inference on the topic model, conditioned on the content, may result in topic vectors. A topic vector for content may be a collection of probabilities (or at least magnitudes) representing the degree to which each topic is present within the given content. A topic, itself, may be a collection of probabilities (or at least magnitudes) representing the degree to which each of many possible words is present within a topic.

In some implementations, categorization 302/304 via probabilistic modeling may go beyond topic clustering. For example, OP 10 may sample a probabilistic process that may generate Gantt charts from a prior probability distributions over Gantt charts. A Gantt chart may include in this example context, projects, sub-projects, sub-sub-projects, and so forth. It may also include names or other IDs of people who may work on one or more project spreading their total effort across one or more projects. It may include timelines for projects, where projects all tend to be, e.g., 4 years long, and where projects tend to be, e.g., 4× longer than their sub-projects which may average, e.g., a year in length, and so forth with sub-sub-projects being on average, e.g., 3 months in length. In some implementations, content authored within a project may have a time stamp that may fit the duration of the project (or sub-project or sub-sub-project, etc.). Each project, sub-project, or sub-sub-project may have a distribution over the occurrences or co-occurrences of words in that topic. Content authored within a project may have word statistics similar to other content within the same project (or sub-project or sub-sub-project, etc.). The authors and any recipients/readers of an element of content may fit the overall distribution over people participating within a project (or sub-project or sub-sub-project, etc.).

It will be appreciated that any technique capable of categorizing content may be used without departing from the scope of the disclosure. For instance, the amount of content N may be chosen dynamically by a relevance algorithm. In another example, all the content within some radius of the exemplar content may be found and categorized into the appropriate channel. In another example, spheres may be defined around the ends of the topic vectors of each of the exemplar contents, and all of the contents within the region of intersection of these spheres may be found and categorized into the appropriate channel. As another example, the topic vectors may be clustered by a clustering module. For instance, the clustering module may be K-Means. In another example, OP 10 may order the display of content via date, or according to some other property, like distance within topic vector space (e.g., the measure of nearness may be a Euclidean distance in a vector space of the topic vectors). Additionally, it will be appreciated that probabilistic programs are only one such representation of probabilistic models, and that the generative models may be, but are not necessarily, represented as probabilistic programs. As such, the use of any particular categorizing algorithm used for machine learning with the probabilistic models should be taken as example only and not to otherwise limit the scope of the disclosure.

In some implementations, once a collection of content is found using one or more example contents, the contents may be given a label to mark them as all belonging to a cluster or class of contents within a content ontology, which may be output by OP 10 for use in displaying channels/feeds or file ontologies to user 50. For example, each content element (e.g., email) may have associated data that records the probability that it participates in each feed, sub-feed, sub-sub-feed, etc. In some implementations, this record may be truncated by OP 10 to only store the top categorization of the content, or the k most likely categorizations of the content. For example:
email #1: {feed 1 prob=0.9, {feed 1.a prob=0.5, feed 1.b prob=0.4}, feed2 prob=0.1}

In some implementations, the second feed category may be a sub-feed of the first feed category. For instance, the second feed category may be a subcategory (or sub-subcategory, sub-feed, child feed, etc.) of the first feed category. For example, the first feed category may be labeled “Project 1” and the second feed category may be labeled a subcategory “Project 1a.” In some implementations, the second feed category may be a non-compartmentalized category (e.g., parent feed). For instance, the second feed category may be entirely unrelated and therefore separate from the first feed category. For example, the first feed category may be labeled “Project 1” and the second feed category may be labeled “Project 2.”

In some implementations, as noted above, OP 10 may employ a labeling and/or tagging scheme that enables some or all of the identified 300 content to be organized by an ontology or ontologies, which may generally be referred to as labels. In some implementations, the ontology may use multiple labels per content. As noted above, the ontology does not need to be hierarchical or strictly hierarchical, although it may be if desired. In some implementations, OP 10 may enable the user, if desired, to manually adjust the tag hierarchy, if such a hierarchy exists. In some examples, the ontology may have a single content (e.g., email) appear in multiple categories if multiple labels are assigned to it. In other words, the ontology may be an “over-lapping” ontology. Thus, when user 50 views a collection of content that each has the same label, new incoming documents to which OP 10 applies the same label may automatically appear in the view of the associated feed category with the label. For example, OP 10 may enable a user to manually apply any set of tags to any email. For instance, an email from one's spouse requesting that one be home from work early may be tagged with both a tag “work schedule” and another tag “home schedule” simultaneously. The “home schedule” tag may be a sub-tag of the general “home” tag/category. The “work schedule” tag may be a sub-tag of the general “work” tag/category. In the example, when one brings up the “home” feed, this email may be visible. When one brings up the “home schedule” feed, this email may be visible. When one brings up the “work” feed, this email may be visible. When one brings up the “work schedule” feed, this email may be visible. In some implementations, a machine learning portion of OP 10 may apply or suggest these tags automatically, and may become more and more accurate at applying or suggesting these tags after receiving 306 feedback from the user as discussed below. Thus, it will be appreciated that particular ontology may be used (singly or in combination) without departing from the scope of the disclosure.

It will be appreciated that the concepts of ontology and channels may be used interchangeably with the present disclosure. That is, a feed category may be any type of organizational/categorizable technique of related content (e.g., one, two, or three dimensions using groupings such as spatial clusters, containers, graphs, folders, or other visual elements). In some implementations, when using “channels,” each content may have none, one, or more labels indicating that it belongs to no channels, one or many channels, respectively. In some implementations, each label (or some of the labels) may also include a probability indicating how likely that label is to be correctly assigned to specific content.

In some implementations, the above-noted labels may be produced by the machine learning portion of OP 10, and may be used to display the content in the above-noted folders (e.g., channels/feed category) and/or in a folder hierarchy, or other technique. In some implementations, OP 10 may enable a view such that content (e.g., emails) in the user's inbox are removed and immediately show up within folders in their email client application. In some implementations, these folders may be labeled as “channels” and there may be no folder hierarchy. In some implementations, the folders may be labeled according to a particular profession. For instance, assume for example purposes only that user 50 is an attorney. In the example, the folders may be labeled by, e.g., client (or other attorney related subject) (e.g., via OP 10), and each client folder may have sub-folders for each legal matter, project, or other activity pertaining to that client/project.

In some implementations, OP 10 may automatically remove the emails from the inbox to the appropriate feed category, or may not remove the emails from the inbox to the appropriate feed category until the user has an opportunity to view them and they are marked “read.” In some implementations, OP 10 may wait to “file” an email until the user has had a chance to respond or react to the email in some way. In some implementations, OP 10 may recognize when the user has read an email, but is not truly ready to file in the appropriate channel/feed category. For example, OP 10 may be able to recognize states of an email, such as when the user has responded to an email by replying something like, “let me look into this and get back to you tomorrow.” In some implementations, OP 10 may determine when the user is truly done with an email (or other type of message) using a “done estimator” via a naive Bayes model of word or n-gram frequencies. In some implementations, other states/modes of a typical work flow may be used. For instance, non-limiting examples may include, (1) notification/alert that one or more content(s) is highly relevant right now, (2) reading those one or more content(s), (3) drafting/creating a response regarding one or more content(s), (4) awaiting feedback on the draft from other people, (5) task completed, decision made, etc.

In some implementations, OP 10 may receive 306 user feedback to change the categorization of a first content of the first portion of the plurality of content in the first feed category to the second feed category. For instance, assume for example purposes only that user 50 does not fully like the categorization ontology OP 10 produced. In the example, further assume that an email was originally categorized/labeled into the first feed category using the first probabilistic model, but that user 50 has decided that the email would be better categorized/labeled into the second feed category. In some implementations, the user feedback may be received 306 via a user interface of a second computing device (e.g., client electronic device 50) and sent to computer 12. In the example, user 50 (e.g., via OP 10) may provide user feedback (e.g., feedback 17) to change the categorization of that email from the first feed category to the second feed category (e.g., by changing the label of the email, physically “drag and drop” the email into the second feed category, different folder(s), container(s), cluster(s), etc.), which may be received 306 via OP 10 (e.g., via network 14, client application 26, etc.).

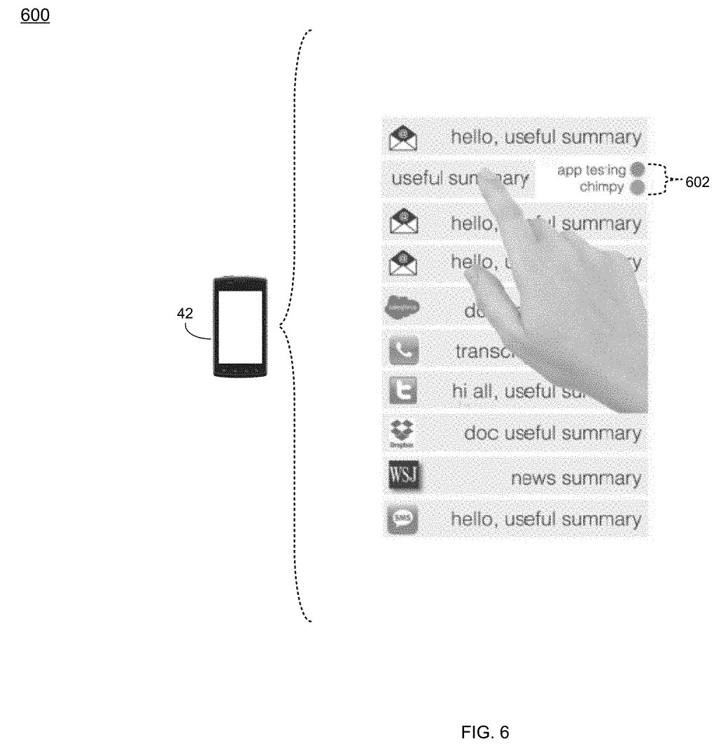

In some implementations, the user feedback received 306 via the user interface may include a gesture. For instance, and referring at least to the example implementation of FIG. 6, an example user interface 600 is shown. In the example, user interface 600 (e.g., via OP 10) may enable user 50 to use a “swipe” gesture on the content to change the categorization of the content to a different feed category. In some implementations, upon swiping, OP 10 may provide suggested alternative feed categories (alternative suggested feed categories 602) predicted by OP 10 to better categorize the content (e.g., using an example learning algorithm). In some implementations, a swiping gesture all the way in a particular direction (or other known gesture or user action) may cause OP 10 to use the content to seed (e.g., create) a new feed category.

It will be appreciated that any other types of gestures or user actions may be used for the user feedback without departing from the scope of the disclosure. For instance, swiping in any direction, “tapping” or “clicking” on a particular spot on the user interface, shaking, etc. may also be used as user feedback. As such, the specific example of swiping should be taken as example only and not to otherwise limit the scope of the disclosure.

In some implementations, the user interface of OP 10 may include a slider with, e.g., three example settings, “good label,” “neutral label,” and “bad label” to help user 50 provide the user feedback. In one example, these sliders may be displayed at the top of each content in the feed category. In some implementations, each of these sliders may start in the neutral position, and user 50 may (via OP 10) move it to “good” or “bad” states. In some implementations, there may be a neutral setting (e.g., in the middle of such a slider), and all of the contents may be neutral except for the top content, which may be initially on (with the slider having a dark grey background), or two or more such contents, if the channel was seeded by two or more contents. In the example, if the user slides any lower email from neutral to on, OP 10 may turn the content dark grey and may snap to the top under the other dark ones. In the example, if the user slides the slider to off, the content may fade away, the other contents may snap up to fill in its space, and (eventually) a small undo message may appear at the bottom of the user interface.

In some implementations, OP 10 may generate 308 a second probabilistic model based upon, at least in part, the user feedback. For instance, and continuing with the above example where user 50 (e.g., via OP 10) provides user feedback 17 to change the categorization of an email previously categorized 302 by OP 10 in the first feed category, e.g., to the second feed category, (e.g., by changing the label of the email, physically “drag and drop” the email into the second feed category, different folder(s), container(s), cluster(s), etc.), which may be received 306 via OP 10 (e.g., via network 14). In the example, OP 10 may generate 308 a second probabilistic model using user feedback 17, where (as noted above) at least one of the first probabilistic model and the second probabilistic model may be generated 308 via machine learning. In some implementations, OP 10 may use Bayesian probabilistic models, as described in the Gantt chart description above. Generally, the received 306 user feedback may be used to “condition” any variable or parameter for this probabilistic model. In some implementations, OP 10 may leverage user feedback 17 in order to improve the estimate of what content ontologies/channels/feeds are desired by user 50 and/or to improve an existing channel/feed category.

In some implementations, OP 10 may reorganize 310 the categorization of a second content of the first portion of the plurality of content in the first feed category based upon, at least in part, the second probabilistic model. For instance, and continuing with the above example where user 50 (e.g., via OP 10) provides user feedback 17 to change the categorization of an email previously categorized 302 by OP 10 in the first feed category to the second feed category (e.g., by changing the label of the email, physically “drag and drop” the email into the second feed category, different folder(s), container(s), cluster(s), etc.), which may be received 306 via OP 10 (e.g., via network 14). In the example, OP 10 may review some or all of the plurality of content that was originally categorized 302 according to the first probabilistic model, and may reorganize 310 (e.g., recategorize) that content according to the second probabilistic model generated based upon user feedback 17. For instance, assume for example purposes only that a different email (e.g., email “A”) was labeled/tagged and categorized 302 to be placed in the first feed category according to the first probabilistic model. In the example, based upon user feedback 17, OP 10 may use the second probabilistic model to determine that email “A” should now be categorized to be placed in the second feed category, since it may now have a new/updated label assigned by OP 10 based upon the second probabilistic model. Thus, in the example, user feedback 17 may be used by OP 10 to further refine its labeling/categorization for future content according to the second probabilistic model, but may also be used to reorganize 310 the content previously categorized according to the first probabilistic model (e.g., before the user feedback was received to generate the second probabilistic model). It will be appreciated that user feedback need not always move a content from a first feed category to a second feed category. For instance, in some implementations, reorganizing 310 the categorization of the second content of the first portion of the plurality of content in the first feed category may include removing 314 the second content from the first feed category. In the example, OP 10 may remove it from a feed (e.g., the first feed category) and OP 10 may then determine what to do with it (e.g., using one or more future probabilistic models).

In some implementations, OP 10 may generate/refine a new probabilistic model each time user feedback is received, making the above-noted reorganization an iterative process. In some implementations, OP 10 may generate a message (e.g., a pop-up message) asking if the user wants to generate/refine the probabilistic model and/or have the new probabilistic model applied to the existing and/or new content.

In some implementations, receiving 306 the user feedback may include receiving 312 user feedback from a plurality of users. For instance, assume for example purposes only that two users (e.g., user 50 and user 38) both have access to the same feed categories or content. In the example, further assume that it is user 38, and not user 50, that provides the user feedback to change the categorization of that email from the first feed category to the second feed category. In the example, OP 10 may similarly change the categorization of that email for the feed categories of user 50 as well as user 38. In some implementations, shared access may not be required to receive 312 user feedback from a plurality of users. For example, assume that user 50 and user 48 do not know each other nor do they share information with one another. Further assume they both follow the Red Sox and Celtics. Further assume that user 48 makes one channel for updates about the Red Sox and another about the Celtics (or puts these two teams in two separate sub-feeds under their “sports” feed). In the example, OP 10 may notice that user 50 also follows both teams. OP 10 may automatically suggest to user 50 that he too may like to have separate channels for the two sports teams under a main “sports” feed. User 50 may manually reorganize this if he likes, providing additional new feedback to OP 10. As such, the example of only a single user providing user feedback to generate the second probabilistic model should be taken as example only and not to otherwise limit the scope of the disclosure.

In some implementations, the above-noted labels assigned to content according to the probabilistic model may be delivered, served, shared, or otherwise made available so that they may be used by other applications. For example, OP 10 may enable the display of emails according to tags as noted above. OP 10 may apply the tags it learns within the email client, so that if a user logs into the email client user interface to look at only their email, the same tags may be present. As another example, users in a project may share to other users assigned to the same project their tags/ontology for how they organize their sub-projects and sub-sub-projects and so forth.

In some implementations, the labels may be made available, not to just anyone, but may be made available with restricted access. For instance, the learned Gantt chart organization may be exported to a project planning tool so that the team may view visually the emergent machine inferred organization of their project. However, assume for example purposes only that one does not want people outside one's company understanding the overall project with this kind of global view, or one only wants a few managers of the project to have this overall view. In the example, OP 10 may enable the user to only share the tags and overall inferred project organization to those who are authorized to have access to them (e.g., using known authorization techniques). As another example, assume that Human Resources is using the labels/tags to understand the emergent behavior and communications patterns in the company. For example, they may want to know that a certain person improves the probability of success of any given project with which they interact, and therefore they deserve a salary raise. This may be confidential information for human resources.

In some implementations, OP 10 may include a user interface for selecting one or more contents to be converted into a task item, in which case OP 10 may use one of the above-noted learning algorithms to extract information from the content and populate structured fields for the task, such as, e.g., task name, priority, requester, followers, owner, due date, duration, effort level, task type, links to other relevant documents, etc. In some implementations, OP 10 may enable the structured data with the above information to be output as a .CSV or other file format, which may then be ingested or displayed in a spreadsheet, CRM, workflow or task management tool, or other tabular or database system.

It will be appreciated that OP 10 may be used for other purposes without departing from the scope of the disclosure. For instance, OP 10 may be used for auto time carding. For example, OP 10 may analyze content (e.g., emails, documents, and edit logs), and may use this information to determine when/how long a particular user was working on various content and/or the various projects associated with the content. OP 10 may also infer from this information an estimate of how many words per minute a person produces when working on a document or other content. Given that OP 10 may cluster content, OP 10 may therefore infer how much time and which times the user spent on each activity. For instance, the activities may be legal matters and the user(s) may be lawyer(s), or the activities may be engineering projects and the user(s) may be engineer(s), etc. In some implementations, OP 10 may use the inferences to auto-populate or auto-suggest a time-card. For instance, a user may work on a given project with 60% of their effort on Monday and 20% of their effort on Tuesday, and no further effort on the other days of the week. In the example, OP 10 may recognize this and pre-populate their time-card with that information. In some implementations, this auto-populated time-card may then be reviewed and possibly edited by the user (or administrator) as a detailed report or prefilled entries for final entry into a billing system or time tracking system.

In some implementations, OP 10 may perform inference to learn rules for filing content. For instance, as noted above, these rules may be probabilistic in nature, which may be referred to as automated induction of probabilistic programs. An example of a probabilistic filing rule may be, e.g., when a document is from <xx>, then 60% of the time that document receives the <yy> label. In some implementations, OP 10 may choose the most relevant and/or impactful time to display or send particular information to the user(s). For example, OP 10 may decide to turn on the throb that calls someone's attention to a particular feed at a particular time. In the example, assume they are working on a provisional patent application for Company X in one feed, and they have a second feed for a second Company X patent application. Further assume that these two patent applications are both under an omnibus feed for Company X. If the person is actively reading feed 1, and a new message comes in on feed 2, then OP 10 may make the feed 2 indicator throb because it knows the user is actively thinking about Company X patent applications in feed 1, and this is likely not a distraction and may be important and relevant to what the user is are doing.

In some implementations, OP 10 may be used to share links within a group. For instance, users in a group of users may browse the web and find useful web pages. They may share these links in some way, for example, by sharing their entire browser history with OP 10, by sharing their browser bookmarks with OP 10, by indicating to OP 10 that they want to share a page, etc. OP 10 may then analyze the text and metadata of these web sites similarly to how OP 10 may analyze emails or other documents and apply labels to each of the web pages. In some implementations, these web pages or links to these web pages may become documents viewable in channels or other ontologies, or within the user's email browser or other browser.

In some implementations, the content labels from OP 10 may be used to better understand which projects are active, what kinds of communication is happening in them, who is working on which ones, and when is activity happening within each project. For example, at the top of a feed, the user interface may have icons for each of the people who are presently reading or working within that feed. As another example, the feed information may be exported to a visualize tool along the lines of a project management tool, where a manager may see who was working on which projects at what times and for how many hours per day. In some implementations, the projects may be a sales process, and OP 10 may provide information for enhancing management of the sales process and/or collaboration and/or communication in the sales process. In other examples, the process may be an engineering development or other kind of business process.

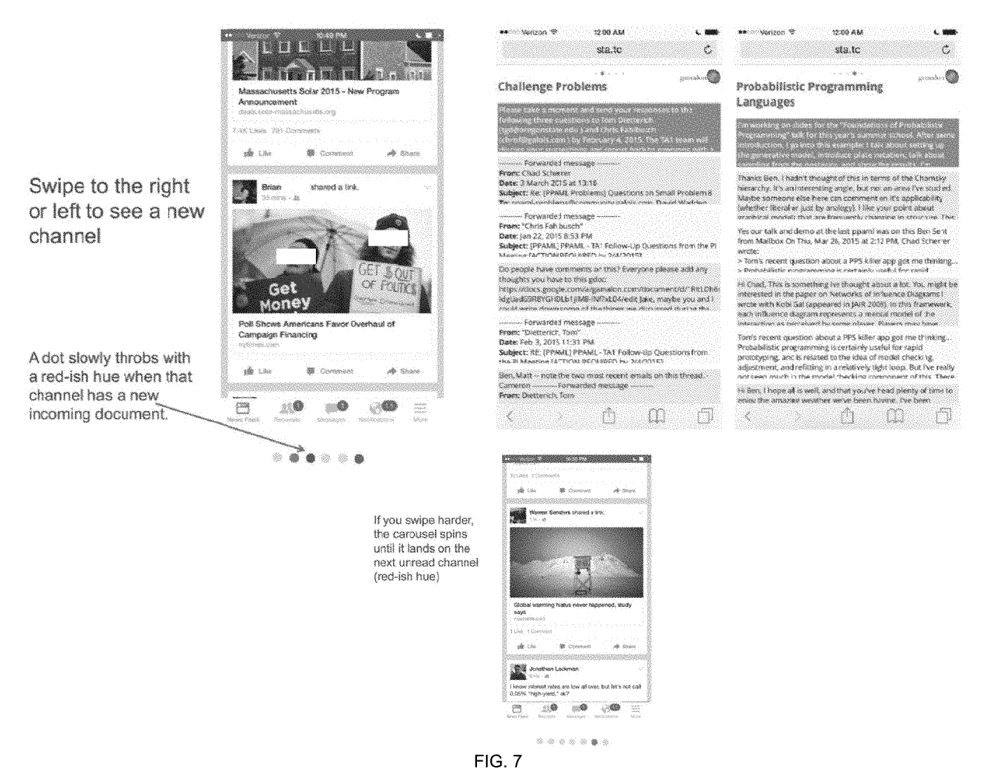

It will be appreciated that there may be various ways to view/display content, access content, provide user feedback for content, etc. according to the above disclosure. The various example and non-limiting views, access controls, displays, colors, layout, etc. are shown via example implementations FIGS. 7-15. For example, the user may define which topics they wish to see separate from one another and may view all communication not only by the type of communication (e.g., the email client for emails, IM for instant messages, phone for text messages, etc.) but may also/alternatively view communication in a single interface organized by conceptual topic. For example, the user may use a touch screen gesture to view a new list. The gesture may be any gesture, e.g., an up/down/left/right/diagonal swipe, touching, clicking, etc. The user may jump to a desired list (e.g., channel) without scrolling. There may be a visual indication of how many lists there are in total. The list may be an indication as a collection of icons. The icons may be arranged in a row, column, grid, etc. An icon may change color, size, shape, pulsate, lights up, flashes, or in some way visually indicate when new document(s) have arrived in its list that the user may want to view (e.g., designed so that it does not distract the user's attention from the list the user is currently focused on viewing, but makes the user peripherally or ambiently aware that there may be other lists that the user may want to give attention). OP 10 may use the machine learning portion to adapt the design to the user's attention levels and focus levels so that the visual indication is optimally peripheral or ambient. In some implementations, the user may provide reinforcement feedback to OP 10 to be either more or less forceful in calling their attention to other matters with new incoming documents. In some implementations, this feedback may be implicit in the users interactions with OP 10 and the frequency with which they are distracted. In some implementations, the user interface may include a sliding bar for the user to control how forcefully OP 10 calls their attention to new documents in other lists. As such, the example figures of any user interface, specific gestures, etc. should be taken as example only and not to otherwise limit the scope of the disclosure.

The terminology used herein is for the purpose of describing particular implementations only and is not intended to be limiting of the disclosure. As used herein, the singular forms “a”, “an” and “the” are intended to include the plural forms as well, unless the context clearly indicates otherwise. As used herein, the language “at least one of A, B, and C” (and the like) should be interpreted as covering only A, only B, only C, or any combination of the three, unless the context clearly indicates otherwise. It will be further understood that the terms “comprises” and/or “comprising,” when used in this specification, specify the presence of stated features, integers, steps (not necessarily in a particular order), operations, elements, and/or components, but do not preclude the presence or addition of one or more other features, integers, steps (not necessarily in a particular order), operations, elements, components, and/or groups thereof.

The corresponding structures, materials, acts, and equivalents (e.g., of all means or step plus function elements) that may be in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications, variations, substitutions, and any combinations thereof will be apparent to those of ordinary skill in the art without departing from the scope and spirit of the disclosure. The implementation(s) were chosen and described in order to explain the principles of the disclosure and the practical application, and to enable others of ordinary skill in the art to understand the disclosure for various implementation(s) with various modifications and/or any combinations of implementation(s) as are suited to the particular use contemplated.

Having thus described the disclosure of the present application in detail and by reference to implementation(s) thereof, it will be apparent that modifications, variations, and any combinations of implementation(s) (including any modifications, variations, substitutions, and combinations thereof) are possible without departing from the scope of the disclosure defined in the appended claims.

What is claimed is:

1. A computer-implemented method comprising:
identifying, by a computing device, a plurality of content from at least one source;
categorizing a first portion of the plurality of content in a first feed category based on a first probabilistic model;
categorizing a second portion of the plurality of content in a second feed category based on the first probabilistic model;
receiving user feedback to change the categorization of a first content of the first portion of the plurality of content in the first feed category to the second feed category;
generating a second probabilistic model based upon, at least in part, the user feedback; and
reorganizing the categorization of a second content of the first portion of the plurality of content in the first feed category based upon, at least in part, the second probabilistic model.

2. The computer-implemented method of claim 1 wherein the second feed category is a sub-feed of the first feed category.

3. The computer-implemented method of claim 1 wherein reorganizing the categorization of the second content of the first portion of the plurality of content in the first feed category includes removing the second content from the first feed category.

4. The computer-implemented method of claim 1 wherein the user feedback is received via a user interface of a second computing device.

5. The computer-implemented method of claim 4 wherein the user feedback received via the user interface includes a gesture.

6. The computer-implemented method of claim 1 wherein receiving the user feedback includes receiving user feedback from a plurality of users.

7. The computer-implemented method of claim 1 wherein at least one of the first probabilistic model and the second probabilistic model is generated via machine learning.

8. A computer program product residing on a computer readable storage medium having a plurality of instructions stored thereon which, when executed across one or more processors, causes at least a portion of the one or more processors to perform operations comprising:
identifying a plurality of content from at least one source;
categorizing a first portion of the plurality of content in a first feed category based on a first probabilistic model;
categorizing a second portion of the plurality of content in a second feed category based on the first probabilistic model;
receiving user feedback to change the categorization of a first content of the first portion of the plurality of content in the first feed category to the second feed category;
generating a second probabilistic model based upon, at least in part, the user feedback; and
reorganizing the categorization of a second content of the first portion of the plurality of content in the first feed category based upon, at least in part, the second probabilistic model.

9. The computer program product of claim 8 wherein the second feed category is a sub-feed of the first feed category.

10. The computer program product of claim 8 wherein reorganizing the categorization of the second content of the first portion of the plurality of content in the first feed category includes removing the second content from the first feed category.

11. The computer program product of claim 8 wherein the user feedback is received via a user interface of a computing device.

12. The computer program product of claim 11 wherein the user feedback received via the user interface includes a gesture.

13. The computer program product of claim 8 wherein receiving the user feedback includes receiving user feedback from a plurality of users.

14. The computer program product of claim 8 wherein at least one of the first probabilistic model and the second probabilistic model is generated via machine learning.

15. A computing system including one or more processors and one or more memories configured to perform operations comprising:
identifying a plurality of content from at least one source;
categorizing a first portion of the plurality of content in a first feed category based on a first probabilistic model;
categorizing a second portion of the plurality of content in a second feed category based on the first probabilistic model;
receiving user feedback to change the categorization of a first content of the first portion of the plurality of content in the first feed category to the second feed category;
generating a second probabilistic model based upon, at least in part, the user feedback; and
reorganizing the categorization of a second content of the first portion of the plurality of content in the first feed category based upon, at least in part, the second probabilistic model.

16. The computing system of claim 15 wherein the second feed category is a sub-feed of the first feed category.

17. The computing system of claim 15 wherein reorganizing the categorization of the second content of the first portion of the plurality of content in the first feed category includes removing the second content from the first feed category.

18. The computing system of claim 15 wherein the user feedback is received via a user interface of a computing device.

19. The computing system of claim 18 wherein the user feedback received via the user interface includes a gesture.

20. The computing system of claim 15 wherein receiving the user feedback includes receiving user feedback from a plurality of users.

21. The computing system of claim 15 wherein at least one of the first probabilistic model and the second probabilistic model is generated via machine learning.
